(19) United States
(12) Patent Application Publication
(10) Pub. No.: US 2005/0228749 A1
(43) Pub. Date: Oct. 13, 2005

(54) Pay bills and accumulate wealth using a personalized financial debit-credit combination card that allows the user to make payment transactions against the user's own funds and encourages the user to pay back the account on a monthly basis for the charges made. If payments are not made punctually, then the account holder is also responsible for paying interests, late fees, and processing charges to his or her own account

(76) Inventor: Carlos Andres Lozano, Pembroke Pines, FL (US)

Correspondence Address: Carlos Andres Lozano, 2141 NW 160 Terrace, Pembroke Pines, FL, 33028, US

(21) Appl. No.: 10/821,610

(22) Filed: Apr. 9, 2004

(51) Int. Cl. G06F 17/60

(52) U.S. Cl. 705/39

(57) ABSTRACT

This patent application makes available to a specific group of consumers a financial card that provides the services that existing debit and credit cards offer today; with the exception that instead of paying interests and fees to credit lenders, the consumer who uses this card agrees to pay himself or herself for the use of his or her own funds. In other words, with this service, a consumer who has savings in a bank account (in this case a credit line) and elects this service, can make debit transactions against his or her own account and repay himself or herself for the use of the funds, plus finance charges (interests) if payments are late. Thus it gives the consumer the option to increase wealth and at the same time keep from going into more debt. The services offered by this financial card also include a safe alternative to cash; a means of building credit history; an option when having to bail out of emergencies; a flexible alternative when cash or checks are not accepted; savings from having to stock up on traveler's checks or cash when one travels; implicit guarantee of satisfaction because as a consumer one can stop payment, etc.

Pay bills and accumulate wealth using a personalized financial debit- credit combination card that allows the user to make payment transactions against the user's own funds and encourages the user to pay back the account on a monthly basis for the charges made. If payments are not made punctually, then the account holder is also responsible for paying interests, late fees, and processing charges to his or her own account.

### CROSS REFERENCE TO RELATED APPLICATIONS

“Not Applicable”

### STATEMENT OF FEDERALLY SPONSORED RESEARH/DEVELOPMENT

“Not Applicable”

### SEQUENCE LISTING

“Not Applicable”

### FIELD OF INVENTION

This invention pertains to a utility patent to which may be granted to anyone who invents or discovers a new and useful process or a new useful improvement thereof.

### DESCRIPTION OF PRIOR ART

The first recorded use of credit cards in the United States occurred in the early 1900s, when individual department stores, communication companies, hotels and other travel companies, oil companies, and various other businesses began issuing small metal cards to their preferred customers. These cards, sometimes called “metal money”, offered customers an interest-free, deferred payment option. Unlike today's cards, customers could only use their “metal money” with the company or business that issued the card.

The popularity and use of this type of charge card increased until World War II when all use of credit and charge cards was prohibited. After the war ended, however, charge cards bounced back in use and popularity, becoming even more accessible to the general public.

When consumer trends indicated that customers with charge cards were spending more than other consumers, banks became very interested in the potential profit behind the credit card industry. The Franklin National Bank in New York issued the “Charge It” card in 1951, allowing customers to make charges with local retailers. Impressed by the success of the “Charge It” card, other local banks introduced similar services to their local customers.

In 1950, Diner's Club introduced the first universal credit card. Designed especially to meet the travel and entertaining needs of business men, the Diner's Club card could be used at a variety of restaurants, retailers, and other businesses. American Express released their own major universal card in 1958.

Bank of America introduced the first “revolving-credit” card, called BankAmericard in California in the late 1950's. The “revolving-credit” plan gave customers the option to pay their credit card debt all at once, or pay a monthly minimum with interest over a longer period of time, marking an important milestone in the development of the credit card industry.

In the mid-60s Bank of America began licensing other banks across the nation to issue BankAmericards, allowing smaller banks to offer expanded services to their local customers. Master Charge followed suit, and by 1969 almost all independent bank charge cards were licensed through either BankAmericard or Master Charge.

To facilitate international expansion, BankAmericard changed their name to Visa in 1976. Master Charge followed by changing their name to MasterCard.

Bank Card Associations, such as Interlink Association, Western States Bank Card Association, and National BankAmericard, Inc. emerged in the 1960s to manage the enormous task of issuing and processing charge cards across the nation. This made it possible to better regulate, manage and streamline the credit card transaction process.

Electronic card authorizations were introduced in the 1970s, allowing retailers to get approval for transactions 24 hours a day. And by the late 1970s, magnetic strips on the back of cards, along with electronic dial up terminals shortened the transaction approval process to only 1-2 minutes. Now card authorizations can be almost instantaneous, allowing even greater convenience for both the retailer and the customer.

Today, more than 84 million US households hold at least one credit card, with credit card spending levels reaching over $1 trillion dollars each year. Consumers can find a credit card to meet virtually any financial need, special interest, or credit background, and credit cards are now accepted by millions of retailers, whether one shops with traditional merchants, by phone, mail, fax or online. With so many cards available offering so much shopping convenience, it's not hard to tell why credit cards continue to grow in popularity.

### PROBLEMS INVOLVED IN THE PRIOR ART

In the United States consumer debt has more than doubled in the past 10 years to record levels. According to a January 2004 Federal Reserve report, in November 2003 consumers increased their borrowing by $4 billion, or an annual rate of increase of 2.4 percent, pushing total debt to $1.994 trillion. That compares with a record increase of $8.3 billion in October 2003 or an annual rate of increase of 5 percent.

American consumers owed a grand total of $1.9773 trillion in October 2003, according to the latest statistics on consumer credit from the Federal Reserve. That's about $18,654 per US household, a figure that doesn't include mortgage debt. The number is up more than 41% from the $1.3999 trillion consumers owed in 1998.

The majority of consumer borrowing, about 63%, is represented by “non-revolving” debt such as automobile loans. But “revolving” credit, which most typically involves credit cards, is an increasingly significant part of the equation. Revolving debt currently totals $735.3 billion or more than $8,000 per household according to CardWeb.com.; that's about 31% higher than it was five years ago. The figure is 167% more than the $3,000 average revolving debt for households in 1990.

The average American has 2.7 bank credit cards, 3.8 retail credit cards and 1.1 debit cards, for a total of 7.6 cards per cardholder, CardWeb.com said. About 18% of all personal consumption expenditures in the country are made on bank credit cards. Add in retail cards and debit cards and the figure rises to 24%.

The most troubling aspect of all these credit card transactions is that many Americans don't see their income as a spending cap. About 43% of U.S. families spend more than they earn, according to a Federal Reserve study. And on average, Americans spend $1.22 for every dollar they earn, according to Myvesta.org.

Key drivers of debt expansion in recent years include unusually low interest rates; the hot housing market, which has encouraged buyers to stretch for new homes; the aggressive extension of credit to consumers with weak credit scores; and the rising popularity of Internet shopping, in which credit cards are the currency of choice.

### BACKGROUND OF THE INVENTION

The general idea behind this patent application is to make available to a specific group of consumers a financial credit card that provides the services that existing debit and credit cards offer today; with the exception that instead of paying interests and fees to credit lenders, the consumer can opt to pay himself or herself for the use of his or her own funds. In other words, with this service, a consumer who has savings in a bank account (in this case a credit line) and elects this service, can make debit transaction against his or her own account and repay himself or herself for the use of the funds, plus finance charges (interests).

The main advantage of this idea is that it solves the problem that millions of Americans have today as discussed in the “Problems Involved in the Prior Art” section above: it gives consumers the opportunity to increase their savings through the use of their own moneys, while taking advantage of the conveniences that financial cards provide. At the same time, this service will help slow down the lending expansion that is putting Americans in bigger debt every year.

### DESCRIPTION OF DRAWINGS

“Not Applicable”

### DESCRIPTION OF THE PREFERRED EMBODIMENT

As discussed above, consumers can find a credit card to meet virtually any financial need, special interest, or credit background. However, a financial card that allows consumers to use their own personal funds to make transactions and pay themselves interests and fees for the use of those funds is not available today.

The process of issuing and using the financial card proposed in this invention would work as follows: The customer would
Establish a savings account with any bank and strictly for the purpose of making transactions using the financial card proposed here.
Request the financial card from the bank.
Set the maximum amount the savings account can be charged against. In other words set the minimum acceptable balance.
Set the interest rate allowed to be charged for the use of the funds.
Set the monthly minimum payment as a percentage of the funds owed.
Set the monthly fee for late or default payments.
Make transactions using the financial card with any of the millions of retailers that accept credit cards today.
Once the card is in use, every month the bank or agency lending the service sends a statement to the consumer indicating the charges made and payment due. The statement also shows interests charged for the period if a balance is due, as well as any other applicable fees.
The consumer pays his own bank account for the monthly charges.
This financial card also gives customers the option to pay their financial card debt all at once, or pay a monthly minimum with interest charged over a longer period of time.

This financial card will allow the consumer to take advantage of all the benefits that credit and debit cards offer today including a safe alternative to cash, build credit history, bail out of emergencies, flexibility when cash or checks are not accepted, savings from having to stock up on traveler's checks or cash when one travels, implicit guarantee of satisfaction because as a consumer one can stop payment, etc. However, the advantage that separates the financial card proposed here and the financial cards that exist today is that it allows the consumer to pay interests and fees to himself or herself and not to credit lenders; thus it gives the consumer the option to increase wealth while at the same time keeping the consumer from going into more debt.

Furthermore, it is well known that even people who have high incomes, have savings and established credit lines mismanage money, and pay interests on things that they could pay outright. By using the financial card proposed here, these group of people can become less dependable on credit lenders, save money that they would pay out in interests, and actually increase their wealth because instead of paying interests to credit companies they can pay themselves interests (an indirect savings method).

On the other hand, people who do not have savings or established credit can benefit from this idea by simply opening a savings account with a small amount of money and over time slowly deposit money into the account until there is enough money to start making small purchases with the financial card.

Therefore, as opposed to credit cards available in the market today, this card offers the extra advantage that it can be used by both people who have savings and established credit and people who do not have savings or established credit.

The most important secret to this idea for those who elect to utilize it is that it requires some discipline to make it a successful financial tool.

1. I claim that, via my invention, I can make available a financial debit-credit card that allows the consumer to make purchases against his personal savings account (debit), and forces the consumer to repay the funds expended prior to a deadline (credit); otherwise finance charges and fees are assessed against the personal savings account:
